(19) United States
(12) Patent Application Publication
(10) Pub. No.: US 2021/0284021 A1
(43) Pub. Date: Sep. 16, 2021

(54) VEHICULAR CENTRAL CONTROL DISPLAY SYSTEM AND VEHICULAR CENTRAL CONTROL DISPLAY METHOD

(71) Applicants: FUDING PRECISION COMPONENTS (SHENZHEN) CO., LTD., Shenzhen (KY); FOXCONN INTERCONNECT TECHNOLOGY LIMITED, Grand Cayman (KY)

(72) Inventor: CHIA-CHIEH CHENG, New Taipei (TW)

(21) Appl. No.: 16/899,786

(22) Filed: Jun. 12, 2020

(30) Foreign Application Priority Data
Mar. 16, 2020 (CN) 202010183755.5

(51) Int. Cl. B60K 35/00

(52) U.S. Cl. CPC B60K 35/00; B60K 2370/1533; B60K 2370/782; B60K 2370/1438; B60K 2370/126

(57) ABSTRACT

A vehicular central control display system includes a display device, an information acquisition module, a rotator, and a control module. The display device includes a first display area and a second display area. The first display area and the second display area cooperatively display a common interface. The information acquisition module obtains an operation instruction. The control module causes the rotator according to the operation instruction to drive a position change of the second display area relative to the first display area so that the first display area and the second display area form an angle. When the first display area and the second display area form an angle, the control module controls the first display area to display an operation interface and the second display area to display a control interface. The control interface is configured to input control commands for controlling the operation interface.

### FIELD

The subject matter herein generally relates to vehicular displays, and more particularly to a vehicular central control display system and a vehicular central control display method.

### BACKGROUND

Generally, a central control screen system in a vehicle includes either a single large screen or separate screens. The single large screen makes the interior design in the vehicle more concise, and the separate screens provide more distinct operation interfaces.

However, a bottom of the single large screen is a certain distance from the field of view of the driver, which makes operation inconvenient. In the separate screens, the size of each screen is smaller, so the screens are also difficult to view clearly during operation.

### BRIEF DESCRIPTION OF THE DRAWINGS

Implementations of the present disclosure will now be described, by way of embodiments, with reference to the attached figures.

FIG. 1 is a schematic diagram of an embodiment of a vehicular central control display system.

FIG. 2 is a schematic diagram of the vehicular central control display system in a vehicle in a rotated state.

FIG. 3 is a schematic diagram of the vehicular central control display system in the vehicle in a coplanar state.

FIG. 4 is a schematic diagram of another embodiment of the vehicular central control display system in the vehicle in a bent state.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

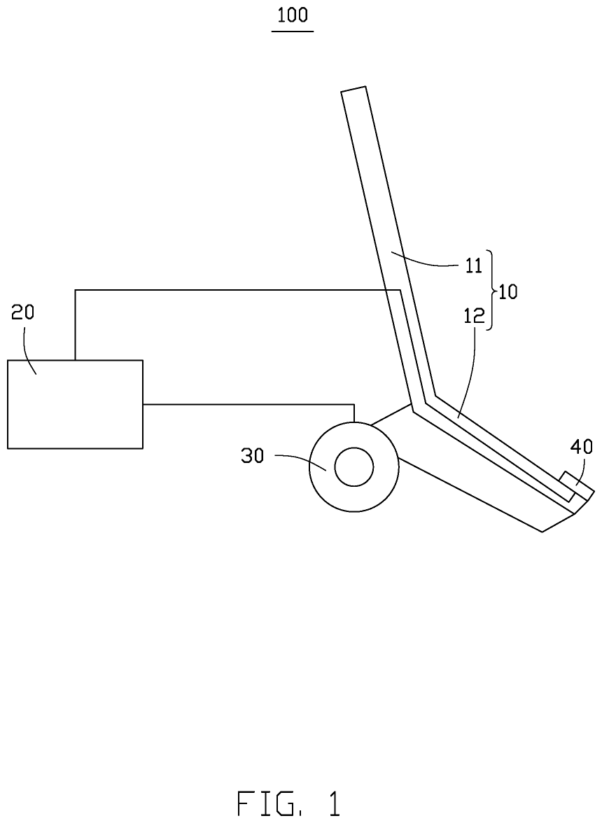

Referring to FIG. 1, an embodiment of a vehicular central control display system 100 includes a display device 10, a control module 20, a rotator 30, and an information acquisition module 40. The display device 10 includes a first display area 11 and a second display area 12. The first display area 11 and the second display area 12 are connected together. The first display area 11 is fixed, and the second display area 12 can be turned toward the first display area 11 to fold the display device 10. In one embodiment, the first display area 11 is disposed above the second display area 12, and the display device 10 is a flexible touch-sensitive display screen.

The control module 20 is communicatively connected to the display device 10. The control module 20 is used to control the first display area 11 and the second display area 12 to display to control an overall display mode of the display device 10.

The rotator 30 is communicatively connected to the control module 20 and the display device 10. The rotator 30 is used to receive a signal from the control module 20 and drive the second display area 12 to rotate to fold the display device 10.

The vehicular central control display system 100 further includes the information acquisition module 40, which is used to acquire an operation instruction of a user. The control module 20 is further used to analyze the operation instruction of the information acquisition module 40 and send a signal to the rotator 30. The control module 20 drives the second display area 12 to change a position relative to the first display area 11 according to the operation instruction to form an angle between the first display area 11 and the second display area 12, and controls the first display area 11 to display an operation interface and the second display area 12 to display a control interface. In one embodiment, the information acquisition module 40 is a sensor. The sensor is used to detect a gesture instruction of the user and transmit the operation instruction to the control module 20. In another embodiment, the information acquisition module 40 is a button, and the user can send an operation instruction to the control module 20 by pressing the button.

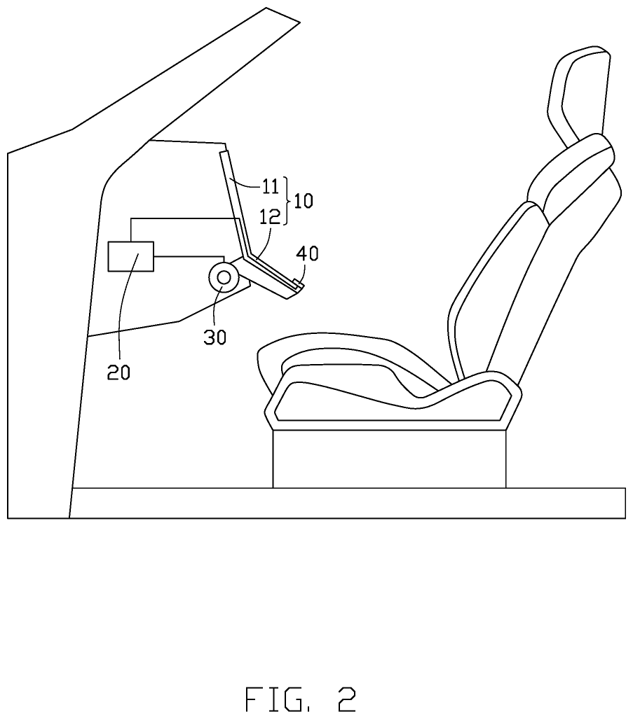

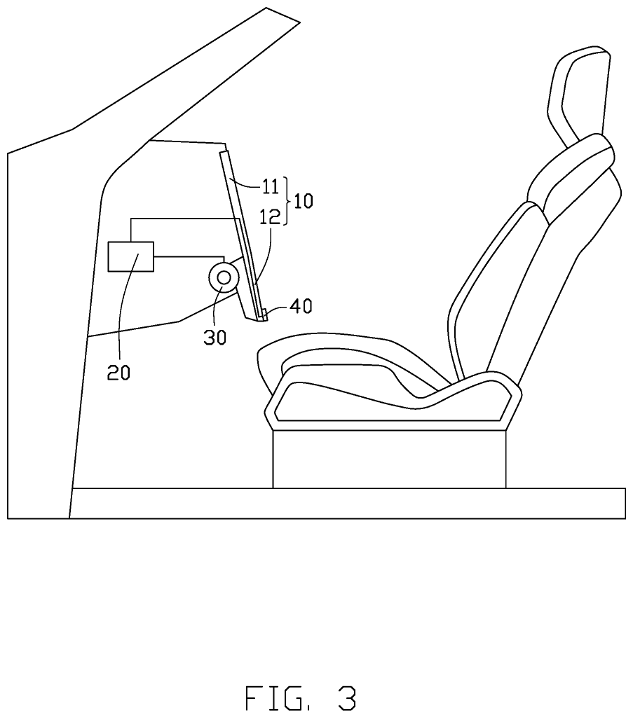

Referring to FIG. 2 and FIG. 3, when the second display area 12 is coplanar with the first display area 11, the control module 20 controls the first display area 11 and the second display area 12 to cooperatively display a common interface. When the second display area 12 forms an angle with the first display area 11, the control module 20 controls the first display area 11 and the second display area 12 to display different interfaces.

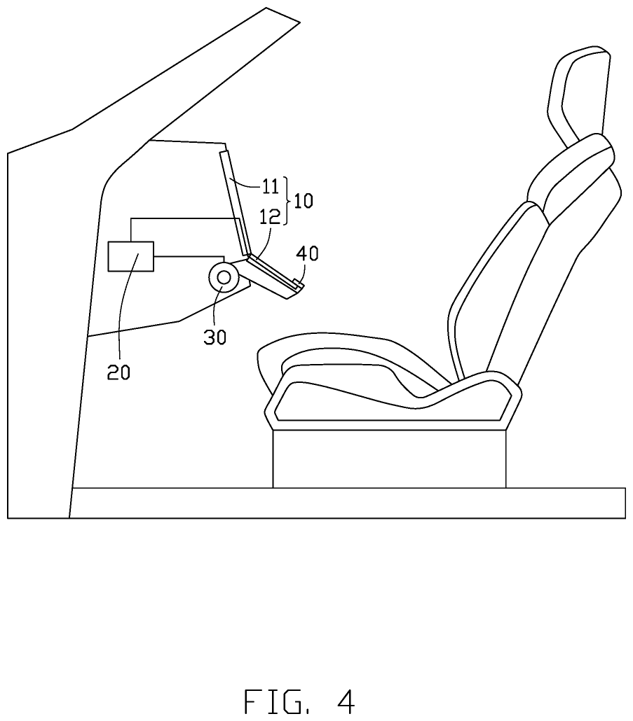

Referring to FIG. 4, in another embodiment, the display device 10 is a screen formed by splicing the first display area 11 and the second display area 12.

The vehicular central control display system 100 further includes a mode switching module (not shown). The mode switching module can switch the second display area 12 to rotate in an automatic mode or a manual mode. In the automatic mode, the second display area 12 is rotated according to a signal of the control module 20. In the manual mode, the second display area 12 is rotated manually.

A vehicular central control display method includes the following steps:

The information acquisition module 40 acquires the operation instruction of the user;

The operation instruction is transmitted to the control module 20;

The control module 20 analyzes the operation instruction and sends a signal to the rotator 30;

The rotator 30 rotates the second display area 12 according to the signal of the control module 20; and

The control module 20 controls the display of the first display area 11 and the second display area 12 according to the position of the second display area 12 relative to the first display area 11.

Specifically, when the information acquisition module 40 detects the user's instruction to rotate the display device 10, the information acquisition module 40 transmits the operation instruction to the control module 20, and the control module 20 analyzes the operation instruction and sends a signal to the rotator 30. The rotator 30 drives the second display area 12 to rotate, and at the same time, the control module 20 controls the first display area 11 and the second display area 12 to display separately, so that the first display area 11 and the second display area 12 display different contents.

When the information acquisition module 40 detects the user's instruction to rotate the second display area 12 away from the first display area 11, the information acquisition module 40 transmits the operation instruction to the control module 20. The control module 20 analyzes the operation instruction and sends a signal to the rotator 30. The rotator 30 drives the second display area 12 to rotate until the second display area 12 and the first display area 11 form a plane, and the control module 20 controls the second display area 12 and the first display area 11 to cooperatively display a common interface.

In some embodiments, the control method may further include: when the second display area 12 needs to be manually adjusted, the mode switching module switches from the automatic mode to the manual mode, and by manually rotating the second display area 12, the control module 20 controls the first display area 11 and the second display area 12 to display accordingly.

It can be understood that in other embodiments, the vehicular central control display system 100 can be used in other environments besides a vehicle. In other embodiments, the user's instruction can also be detected by other sensors. The first display area 11 and the second display area 12 may also be set side-by-side. The display device 10 may further include a third display area rotationally connected to the first display area 11 or on the second display area 12.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A vehicular central control display system comprising:
a display device comprising a first display area and a second display area, the first display area being above the second display area, the first display area and the second display area cooperatively displaying a common interface;
an information acquisition module configured to obtain an operation instruction;
a rotator; and
a control module configured to cause the rotator according to the operation instruction to drive a position change of the second display area relative to the first display area, so that a front surface of the first display area and a front surface of the second display area form an angle less than 180 degrees; wherein:
when the first display area and the second display area form the angle, the control module controls the first display area to display an operation interface and the second display area to display a control interface, the control interface is configured to input control commands for controlling the operation interface.

2. The vehicular central control display system of claim 1, wherein:
the information acquisition module is a sensor for detecting the operation instruction to rotate the second display area; and
the information acquisition module transmits the operation instruction to the control module.

3. The vehicular central control display system of claim 1, wherein:
the information acquisition module is a button configured to be pressed to transmit the operation instruction to the control module.

4. The vehicular central control display system of claim 1, wherein:
when the first display area and the second display area cooperatively display the common interface, the second display area is coplanar with the first display area.

5. (canceled)

6. The vehicular central control display system of claim 1, wherein:
the display device is a flexible touch-sensitive display screen.

7. The vehicular central control display system of claim 1, wherein:
when the second display area is in an automatic mode, the second display area is rotated according to the operation instruction received by the control module; and
when the second display area is in a manual mode, the second display area is rotated manually.

8. A vehicular central control display method comprising:
obtaining an operation instruction for rotating a second display area of a display device relative to a first display area of the display device, wherein the first display area is located above the second display area, a front surface of the first display area and a front surface of the second display area form an angle less than 180 degrees after rotating the second display area;
rotating the second display area relative to the first display area according to the operation instruction so that the second display area forms an angle with the first display area; and
displaying an operation interface on the first display area and a control interface on the second display area.

9. The vehicular central control display method of claim 8, wherein:
when the second display area is coplanar with the first display area, the first display area and the second display area cooperatively display a common interface.

10. The vehicular central control display method of claim 8, wherein:
when the second display area is in an automatic mode, the second display area is rotated according to the operation instruction; and
when the second display area is in a manual mode, the second display area is rotated manually.

11. The vehicular central control display method of claim 10, wherein:
the operation instruction is received by a sensor, and the sensor transmits the operation instruction for rotating the second display area.

12. The vehicular central control display method of claim 10, wherein:
the operation instruction is received by a button, and the button is pressed for transmitting the operation instruction for rotating the second display area.
